(19) United States
(12) Patent Application Publication
(10) Pub. No.: US 2025/0355800 A1
(43) Pub. Date: Nov. 20, 2025

(54) EMPTY PAGE SCAN OPERATIONS IMPROVEMENT

(71) Applicant: Micron Technology, Inc., Boise, ID (US)

(72) Inventors: Christina Papagianni, San Jose, CA (US); Fanqi Wu, Sunnyvale, CA (US); Juane Li, Milpitas, CA (US); Zhongyuan Lu, Boise, ID (US); Murong Lang, San Jose, CA (US)

(21) Appl. No.: 19/188,620

(22) Filed: Apr. 24, 2025

Related U.S. Application Data
(60) Provisional application No. 63/647,409, filed on May 14, 2024.

(51) Int. Cl. G06F 12/02

(52) U.S. Cl. CPC G06F 12/0246

(57) ABSTRACT

Aspects of the present disclosure configure a system component, such as memory sub-system controller, to perform empty page scan operations. The controller detects a condition for performing read disturb handling operations for a portion of a set of memory components. The controller determines that the portion of the set of memory components corresponds to an open block and, in response to determining that the portion of the set of memory components corresponds to the open block, performs empty page scan operations relative to a last programmed word line (WL) of the open block.

### PRIORITY APPLICATION

This application claims the benefit of priority to U.S. Provisional Application Ser. No. 63/647,409, filed May 14, 2024, which is incorporated herein by reference in its entirety.

### TECHNICAL FIELD

Examples of the disclosure relate generally to memory sub-systems and, more specifically, to performing empty page scanning operations in a memory sub-system.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various examples of the disclosure.

FIG. 1 is a block diagram illustrating an example computing environment including a memory sub-system, in accordance with some examples.

FIG. 2 is a block diagram of an example empty page scan module, in accordance with some examples.

FIG. 3 is a block diagram of an example list of conditions for triggering NDEP scan operations, in accordance with some examples.

FIGS. 4-5 are flow diagrams of example methods to perform empty page scan operations, in accordance with some examples.

FIG. 6 is a block diagram illustrating a diagrammatic representation of a machine in the form of a computer system within which a set of instructions can be executed for causing the machine to perform any one or more of the methodologies discussed herein, in accordance with some examples.

### DETAILED DESCRIPTION

Aspects of the present disclosure configure a system component, such as a memory sub-system controller, to perform empty page scanning operations for a memory sub-system, such as NAND detect empty page (NDEP) scan operations. The memory sub-system controller can dynamically select which word lines (WLs) of open blocks are scanned for empty pages based on certain criteria. Namely, rather than blindly selecting only random WLs that are known to be defective for scanning, the controller can also scan WLs that are adjacent (e.g., sequentially follow) a boundary WL or WL that was last programmed in an open block. This can identify potential issues involving read errors that can present themselves early on for correction which reduces potential read errors and improves the overall efficiency of operating the memory sub-system.

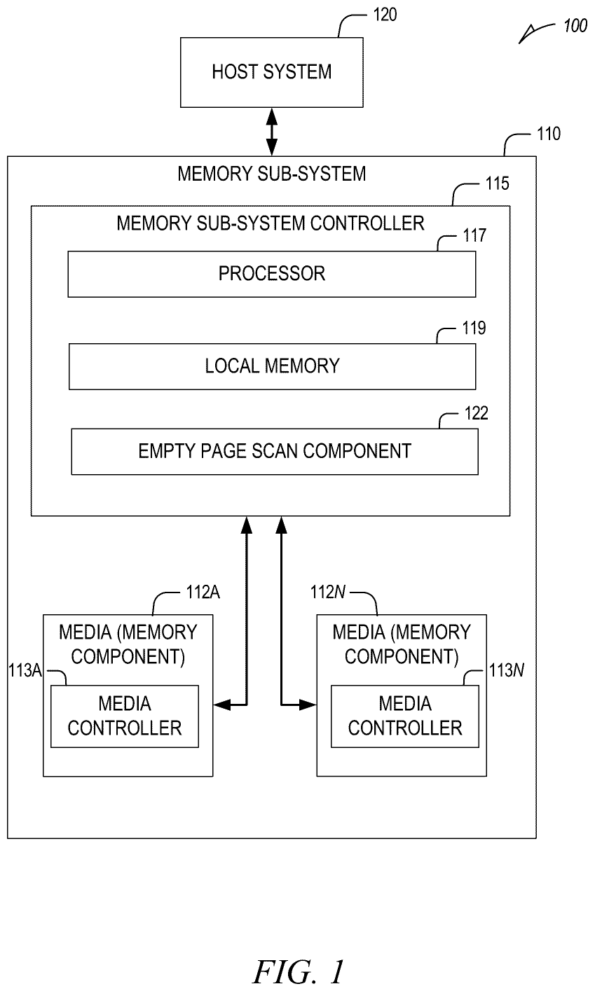

A memory sub-system can be a storage device, a memory module, or a hybrid of a storage device and memory module. Examples of storage devices and memory modules are described below in conjunction with FIG. 1 In general, a host system can utilize a memory sub-system that includes one or more memory components, such as memory devices that store data. The host system can send access requests (e.g., write command, read command, sequential write command, sequential read command) to the memory sub-system, such as to store data at the memory sub-system and to read data from the memory sub-system. The data specified by the host is hereinafter referred to as “host data” or “user data”.

A host request can include logical address information (e.g., logical block address [LBA], namespace) for the host data, which is the location the host system associates with the host data and a particular zone in which to store or access the host data. The logical address information (e.g., LBA, namespace) can be part of metadata for the host data. Metadata can also include error handling data (e.g., ECC codeword, parity code), data version (e.g., used to distinguish age of data written), valid bitmap (which LBAs or logical transfer units contain valid data), etc.

The memory sub-system can initiate media management operations, such as a write operation, on host data that is stored on a memory device. For example, firmware of the memory sub-system may re-write previously written host data from a location on a memory device to a new location as part of garbage collection management operations. The data that is re-written, for example as initiated by the firmware, is hereinafter referred to as “garbage collection data”.

“User data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

A memory device can be a non-volatile memory device. A non-volatile memory device is a package of one or more dice. Each die can comprise one or more planes. For some types of non-volatile memory devices (e.g., NAND devices), each plane comprises a set of physical blocks. For some memory devices, blocks are the smallest area than can be erased. Each block comprises a set of pages. Each page comprises a set of memory cells, which store bits of data. The memory devices can be raw memory devices (e.g., NAND), which are managed externally, for example, by an external controller. The memory devices can be managed memory devices (e.g., managed NAND), which is a raw memory device combined with a local embedded controller for memory management within the same memory device package. The memory device can be divided into one or more zones where each zone is associated with a different set of host data or user data or application.

Conventional memory sub-systems maintain a list of empty pages or blocks which are portions of memory that have previously been erased and are valid for programming or writing data. Sometimes, these portions of memory are subject to leakage in current or voltage. The result of such leaks can cause the portions of memory previously indicated to be empty to erroneously reflect storage of information. This is because rather than storing a current or voltage distribution that represents a value of ‘1’ when read (indicating an empty bit), they store a current or voltage distribution representing a value of ‘0’ when read (erroneously indicating a programmed bit). To detect such errors, conventional memory sub-systems perform empty page scan operations (e.g., NDEP scan operations). These operations involve reading a distribution of current or voltage from a portion of memory previously indicated to be empty to determine whether the portion still reflects an empty state. If the portion no longer reflects an empty state, that portion is refreshed or sent for re-erasure.

Sometimes, the conventional systems perform these NDEP scan operations when some conditions are met. For example, the NDEP scan operations can be performed when a threshold number of read operations are performed on a portion of the memory subsystems. When these conditions are met, the conventional memory systems can initiate probabilistic read disturb handling (PRDH) operations. PRDH is a technique that aims to reduce the likelihood of these errors affecting data integrity. It involves monitoring the number of times each cell is read and using a probabilistic model to predict when the level of disturbance might approach a critical threshold that could lead to data corruption. When the model predicts that a cell is nearing this threshold, the data in the neighboring cells can be refreshed or rewritten to a new location to prevent potential errors. PR DH is generally used to check whether written pages in full or open blocks are still below a threshold limit. PRDH screens out written pages with excessive E 0 charge gain to prevent read bit error rate (RBER) risk if they continue being read. The PRDH technique can select certain pages for read errors. In the case of selecting a page that has already been programmed, a set of WLs corresponding to the page can be identified and used to scan portions of a subblock that contains the page for read errors. In case of selecting an empty page or a page that is in a partially filled block (e.g., an open block), a WL from a specified list of WLs (e.g., those known to have defects or known to be susceptible to stress, such as read stress) can be randomly selected and used to scan portions of a subblock for errors. The selection of a WL from a predetermined list cannot always accurately reflect the state of open blocks with empty pages with respect to possible read errors. Namely, applying a one-size-fits-all approach to empty page scanning operations in case of PRDH operations can result in inaccuracies which lead to wasted resources.

Aspects of the present disclosure address the above and other deficiencies by configuring a system component, such as a memory sub-system controller, to tailor the selection of WLs used in scanning as part of PRDH dynamically. Specifically, the disclosed techniques dynamically select which WLs of open blocks are scanned for empty pages based on certain criteria. Namely, rather than limiting selection to only random WLs that are known to be defective for scanning, the disclosed techniques can also scan WLs that are adjacent (e.g., sequentially follow) a boundary WL or WL that was last programmed in an open block. This can identify potential issues involving read errors that can present themselves early on for correction which reduces potential read errors and improves the overall efficiency of operating the memory sub-system.

In some examples, the memory sub-system controller detects a condition for performing read disturb handling operations for a portion of the set of memory components. The memory sub-system controller determines that the portion of the set of memory components corresponds to an open block. The memory sub-system controller in response to determining that the portion of the set of memory components corresponds to the open block, performs empty page scan operations relative to a last programmed WL of the open block. The memory sub-system controller determines that the last programmed WL corresponds to a boundary WL and, in response to determining that the last programmed WL corresponds to the boundary WL, selects a target WL that is adjacent to the last programmed WL.

In some cases, the memory sub-system controller accesses a next WL that follows the last programmed WL as the target WL. The target WL can be associated with a plurality of subblocks. In such cases, the memory sub-system controller selects a random subblock from the plurality of subblocks and performs the empty page scan operations on the random subblock.

The memory sub-system controller obtains a list of mandatory WLs and selects an additional random subblock from an additional plurality of subblocks associated with an individual WL of the list of mandatory WLs. The memory sub-system controller performs the empty page scan operations on the additional random subblock. In some examples, the memory sub-system includes a three-dimensional (3D) NAND storage device. In some cases, the empty page scan operations include one or more NDEP scan operations. A first of the NDEP scan operations can be associated with selecting a random WL from a list of random empty mandatory WLs, and a second of the NDEP scan operations can be associated with selection of a WL adjacent to a boundary WL for performing the NDEP scan operations.

In some examples, the memory sub-system controller receives a request to read a page from the open block. The memory sub-system controller determines that the page in the open block corresponds to an empty page. The empty page scan operations can be performed in response to determining that the page in the open block corresponds to the empty page. In some cases, the memory sub-system controller refreshes the page in response to determining that the page fails the empty page scan operations. The memory sub-system controller detects the condition includes determining that a number of read operations performed on the portion of the set of memory components transgresses a read threshold count value. The read threshold count value can be associated with each memory component in the set of memory components. The read threshold count value can be dynamically adjusted based on a program erase count (PEC) value of each memory component in the set of memory components. The read disturb handling operations can include probabilistic read disturb handling operations for checking whether programmed pages in blocks are below a threshold limit.

The memory sub-system controller, in response to detecting the condition, determines that a page being read corresponds to a programmed page. In such cases, the memory sub-system controller selects a set of WLs for checking a read bit error rate associated with the page.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing environment 100 including a memory sub-system 110, in accordance with some examples. The memory sub-system 110 can include media, such as memory components 112A to 112N (also hereinafter referred to as “memory devices”). The memory components 112A to 112N can be volatile memory devices, non-volatile memory devices, or a combination of such. In some examples, the memory sub-system 110 is a storage system. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIM M), a small outline DIM M (SO-DIMM), and a non-volatile dual in-line memory module (NVDIMM).

The computing environment 100 can include a host system 120 that is coupled to a memory system. The memory system can include one or more memory sub-systems 110. In some examples, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL), a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NV Me) interface to access the memory components 112A to 112N when the memory sub-system 110 is coupled with the host system 120 by the PCIe or CXL interface. The physical host interface can provide an interface for passing control, address, data, and other signals between the memory sub-system 110 and the host system 120.

The memory components 112A to 112N can include any combination of the different types of non-volatile memory components and/or volatile memory components. An example of non-volatile memory components includes a negative-and (NAND)-type flash memory. Each of the memory components 112A to 112N can include one or more arrays of memory cells such as single-level cells (SLCs) or multi-level cells (MLCs) (e.g., TLCs or QLCs). In some examples, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory.

In some examples, the memory components 112A to 112N can be, but are not limited to, random access memory (RAM), read-only memory (ROM), dynamic random access memory (DRAM), synchronous dynamic random access memory (SDRAM), phase change memory (PCM), magnetoresistive random access memory (MRAM), resistive random access memory (RRAM), negative-or (NOR) flash memory, electrically erasable programmable read-only memory (EEPROM), three-dimensional (3D) NAND, and a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages or blocks that can refer to a unit of the memory component 112 used to store data.

The memory sub-system controller 115 can communicate with the memory components 112A to 112N to perform operations such as reading data, writing data, or erasing data at the memory components 112A to 112N and other such operations. The memory sub-system controller 115 can include hardware such as one or more integrated circuits and/or discrete components, a buffer memory, or a combination thereof. The memory sub-system controller 115 can be a microcontroller, special-purpose logic circuitry (e.g., a field programmable gate array (FPGA), an application specific integrated circuit (ASIC), etc.), or another suitable processor. The memory sub-system controller 115 can include a processor 117 (processing device) configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some examples, the local memory 119 can include memory registers storing memory pointers, fetched data, and so forth. The local memory 119 can also include read-only memory (ROM) for storing microcode. While the example memory sub-system 110 in FIG. 1 has been illustrated as including the memory sub-system controller 115, in another example of the present disclosure, a memory sub-system 110 may not include a memory sub-system controller 115, and can instead rely upon external control (e.g., provided by an external host, or by a processor 117 or controller separate from the memory sub-system 110).

In general, the memory sub-system controller 115 can receive I/O commands or operations from the host system 120 and can convert the commands or operations into instructions or appropriate commands to achieve the desired access to the memory components 112A to 112N. The memory sub-system controller 115 can be responsible for other operations, based on instructions stored in firmware in an active slot or associated with an active firmware slot, such as wear leveling operations, garbage collection operations, error detection and ECC operations, decoding operations, encryption operations, caching operations, address translations between a logical block address and a physical block address that are associated with the memory components 112A to 112N, address translations between an application identifier received from the host system 120 and a corresponding zone of a set of zones of the memory components 112A to 112N. This can be used to restrict applications to reading and writing data only to/from a corresponding zone of the set of zones that is associated with the respective applications. In such cases, even though there may be free space elsewhere on the memory components 112A to 112N, a given application can only read/write data to/from the associated zone, such as by erasing data stored in the zone and writing new data to the zone. The memory sub-system controller 115 can further include host interface circuitry to communicate with the host system 120 via the physical host interface. The host interface circuitry can convert the I/O commands received from the host system 120 into command instructions to access the memory components 112A to 112N as well as convert responses associated with the memory components 112A to 112N into information for the host system 120.

The memory sub-system 110 can also include additional circuitry or components that are not illustrated. In some examples, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory components 112A to 112N.

The memory devices can be raw memory devices (e.g., NAND), which are managed externally, for example, by an external controller (e.g., memory sub-system controller 115). The memory devices can be managed memory devices (e.g., managed NAND), which is a raw memory device combined with a local embedded controller (e.g., local media controllers) for memory management within the same memory device package. Any one of the memory components 112A to 112N can include a media controller (e.g., media controller 113A and media controller 113N) to manage the memory cells of the memory component, to communicate with the memory sub-system controller 115, and to execute memory requests (e.g., read or write) received from the memory sub-system controller 115.

In some examples, the memory sub-system controller 115 can include an empty page scan component 122. The empty page scan component 122 can dynamically select which WLs of open blocks are scanned for empty pages based on certain criteria. Namely, the empty page scan component 122 can scan WLs that are adjacent (e.g., sequentially follow) a boundary WL or WL that was last programmed in an open block. This can identify potential issues involving read errors that can present themselves early on for correction which reduces potential read errors and improves the overall efficiency of operating the memory sub-system 110.

Depending on the example, the empty page scan component 122 can comprise logic (e.g., a set of transitory or non-transitory machine instructions, such as firmware) or one or more components that causes the memory sub-system 110 (e.g., the memory sub-system controller 115) to perform operations described herein with respect to the empty page scan component 122. The empty page scan component 122 can comprise a tangible or non-tangible unit capable of performing operations described herein.

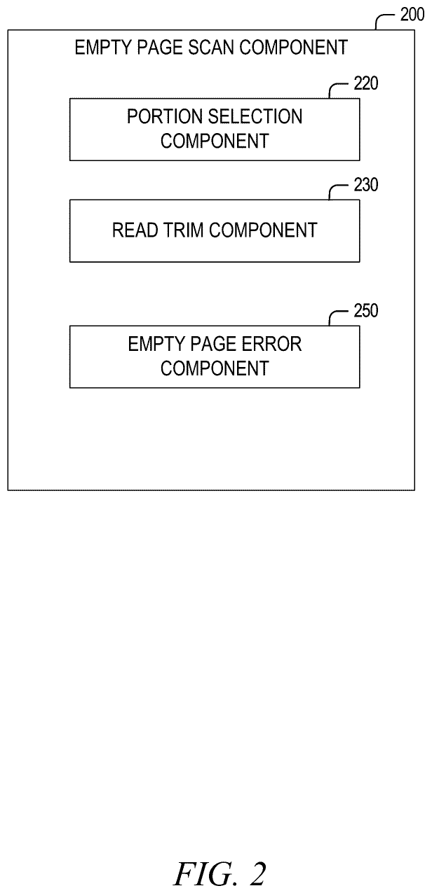

FIG. 2 is a block diagram of an example empty page scan component 200, in accordance with some examples. The empty page scan component 200 can represent the empty page scan component 122 of FIG. 1. As illustrated, the empty page scan component 200 includes a portion selection component 220, a read trim component 230, and an empty page error component 250. The portion selection component 220 can run or execute a PRDH process to check whether written pages in full or open blocks are still below a threshold limit. The portion selection component 220 can select one or more pages for reading to check for RBER risk. To do so, the portion selection component 220 can maintain a read counter for one or more memory components in the set of memory components 112A to 112N. In some cases, a separate read counter can be maintained for each respective memory component (e.g., each memory die).

The portion selection component 220 can determine whether the read counter for an individual memory component in the set of memory components 112A to 112N reaches a threshold read count value (e.g., 5000 or 10000). The threshold read count value can be dynamically set based on a PEC value associated with each of the set of memory components 112A to 112N. In such cases, the portion selection component 220 can initiate the PRDH process. The portion selection component 220 can select a target page for reading to verify whether the target page has read errors in a read scan (e.g., RD scan).

The portion selection component 220 can determine whether the target page is part of an open block or closed block. Namely, if a write cursor is still associated with a block containing the target page, the portion selection component 220 determines that the target page is in an open block that may include one or more empty pages. The portion selection component 220 can determine that the target page is in a closed full block or closed partial block. In such cases, the portion selection component 220 can randomly select one or more WLs that are associated with the closed full block or closed partial block. For example, the portion selection component 220 can select randomly a WL and then identify an adjacent WL, such as WLₙ₊₁ and/or WLₙ₋₁. The portion selection component 220 can then select a random subblock from a plurality of subblocks associated with the one or more WLs. The random subblock can be added to a list of subblocks that are scanned for RBER.

The portion selection component 220 can also access a list of predetermined WLs that are known to have defects or are susceptible to specific stress conditions (e.g. read stress). The portion selection component 220 can select a random WL from the list of predetermined WLs and select an additional random subblock from a plurality of subblocks associated with the randomly selected WL of the list of predetermined WLs. The additional random subblock can be added to a list of subblocks that are scanned for RBER.

The portion selection component 220 can identify the list of subblocks to the read trim component 230. The read trim component 230 stores a current default read trim value associated with the memory sub-system 110. The read trim value represents a particular current and/or voltage distribution that needs to be stored in a given cell or bitline in order to read a logic value of ‘1’ from the given cell. If the current and/or voltage distribution transgresses the read trim value, the current and/or voltage distribution can be determined to correspond to a logic value of ‘0’ and otherwise the current and/or voltage distribution is determined to correspond to a logic value of ‘1’ or vice versa. The read trim component 230 can store the default read trim value by accessing configuration information associated with the memory sub-system 110.

The read trim component 230 can read the subblocks in the list of subblocks and determine whether an RB ER associated with the data read from the list of subblocks transgresses a threshold. If so, the read trim component 230 can perform one or more error correction techniques and/or fold the data.

In some cases, the portion selection component 220 determines that an individual page selected by the PR DH process is in an open block. In such cases, the portion selection component 220 can determine whether the individual page is an empty page. If so, the portion selection component 220 performs one or more NDEP scan operations on one or more blocks or subblocks that include the empty page. For example, the portion selection component 220 can perform a first NDEP scan operation. In the first NDEP scan operation, the portion selection component 220 can access a list of predetermined WLs that are known to have defects or being susceptible to read or other stress conditions. The portion selection component 220 can select a random empty WL from the list of predetermined WLs. The portion selection component 220 select one or more random subblocks from a plurality of subblocks associated with the randomly selected empty WL. The one or more random subblocks can be added to a list of subblocks for which NDEP operations are performed.

In addition, the portion selection component 220 performs a second NDEP scan operation. In this case, the portion selection component 220 retrieves a list of WLs that were last programmed. The portion selection component 220 can identify the last WL in the list that was programmed (e.g., a boundary WL) and select an adjacent next WL. The adjacent next WL corresponds to an empty WL that is adjacent to the last programmed WL and is likely to be programmed next. The portion selection component 220 selects one or more random subblocks from a plurality of subblocks associated with the adjacent next WL. The one or more random subblocks can be added to the list of subblocks for which NDEP operations are performed.

The empty page error component 250 retrieves the current and/or voltage distribution signals from WLs of the list of subblocks for which NDEP operations are performed. The empty page error component 250 compares the current and/or voltage distribution signals from the WLs of the selected portion to the read trim value to which the offset has been added. The empty page error component 250 can compute an error count value based on the comparison. The error count value can represent whether the selected portion is valid for programming. For example, the error count value can indicate a quantity of logical ‘1’ values that have been read from the WLs of the selected portion.

In some examples, the empty page error component 250 compares the quantity of logical ‘1’ values to a threshold value to determine whether the selected portion is valid for programming. In response to determining that the quantity of logical ‘1’ values exceed or transgress the threshold, the empty page error component 250 determines that the selected portion is invalid for programming and can cause the selected page to be refreshed (e.g., sent to be erased again). In response to determining that the quantity of logical ‘1’ values fail to exceed or transgress the threshold, the empty page error component 250 determines that the selected portion is still valid for programming and passes the PRDH scan operations.

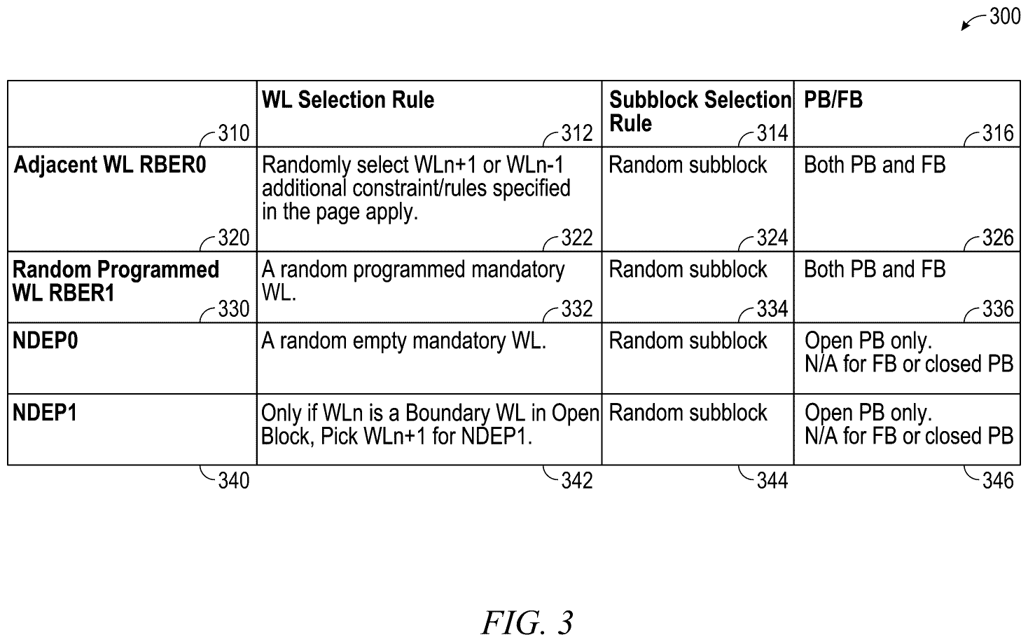

For example, as shown in diagram of FIG. 3, a table 300 can store instructions for the portion selection component 220 of FIG. 2 to follow in selecting subblocks for scanning as part of PRDH operations. For example, a first WL 310 can be selected as part of identifying a target page that is in a closed partial or full block 316. The first WL 310 can be used to identify adjacent word lines 312 and a random subblock 314 is selected from a plurality of subblocks associated with the adjacent word lines 312. As another example, a second WL 320 can be selected as part of identifying a target page that is in a closed partial or full block 316. The second WL 320 can be used to identify and select a random WL from a list of WLs 322 known to have defects or being susceptible to read or other stresses. A random subblock 324 is selected from a plurality of subblocks associated with the random WL.

A first NDEP operation 330 can be performed in case of an empty page being selected by the PRDH operation, such as in case of the empty page being part of an open block 336. A random empty WL can be selected from a list of empty WLs 332 known to have defects or be susceptible to stress (e.g. read stress). A random subblock 334 is selected from a plurality of subblocks associated with the random empty WL. A second NDEP operation 340 can be performed in case of an empty page being selected by the PRDH operation as part of an open block 346. A last programmed WL can be identified and an adjacent WL 342 representing an empty WL can be selected. A random subblock 344 is selected from a plurality of subblocks associated with the empty WL that is adjacent to the last programmed WL.

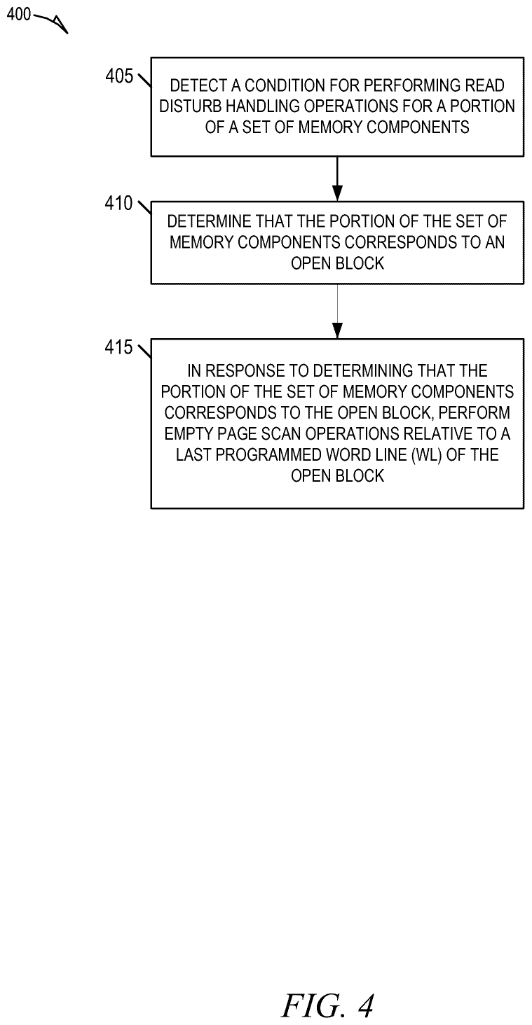

FIG. 4 is a flow diagram of an example method 400 to perform empty page scan operations, in accordance with some examples. Method 400 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 400 is performed by the memory sub-system controller 115 or subcomponents of the controller 115 of FIG. 1. In these examples, the method 400 can be performed, at least in part, by the empty page scan component 200 of FIG. 2. Although the processes are shown in a particular sequence or order, unless otherwise specified, the order of the processes can be modified. Thus, the illustrated examples should be understood only as examples; the illustrated processes can be performed in a different order, and some processes can be performed in parallel. Additionally, one or more processes can be omitted in various examples. Thus, not all processes are required in every example. Other process flows are possible.

Referring now to FIG. 4, the method (or process) 400 begin at operation 405, with the empty page scan component 200 of a memory sub-system (e.g., of processor of the memory sub-system controller 115) detecting a condition for performing read disturb handling operations for a portion of a set of memory components. Then, at operation 410, the empty page scan component 200 determines that the portion of the set of memory components corresponds to an open block and, at operation 415, in response to determining that the portion of the set of memory components corresponds to the open block, performs empty page scan operations relative to a last programmed WL of the open block.

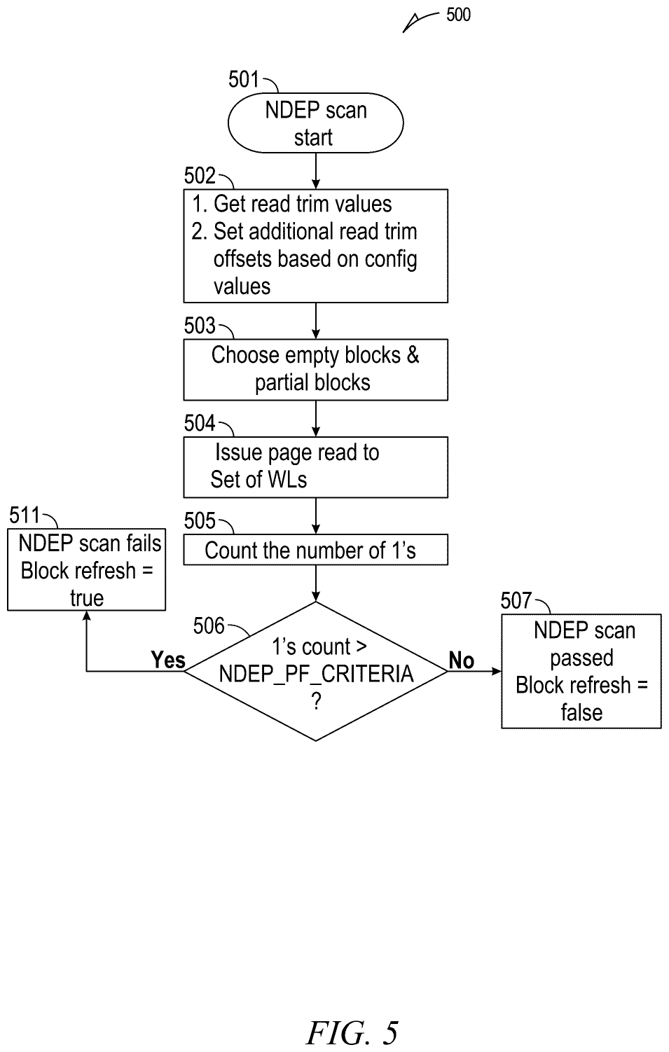

FIG. 5 is a flow diagram of an example method 500 to perform empty page scan operations, in accordance with some examples. Method 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 500 is performed by the memory sub-system controller 115 or subcomponents of the controller 115 of FIG. 1. In these examples, the method 500 can be performed, at least in part, by the empty page scan component 200 of FIG. 2. Although the processes are shown in a particular sequence or order, unless otherwise specified, the order of the processes can be modified. Thus, the illustrated examples should be understood only as examples; the illustrated processes can be performed in a different order, and some processes can be performed in parallel. Additionally, one or more processes can be omitted in various examples. Thus, not all processes are required in every example. Other process flows are possible.

Referring now to FIG. 5, the method (or process) 500 begins at operation 501, with the empty page scan component 200 of a memory sub-system (e.g., of processor of the memory sub-system controller 115) starting an NDEP scan operation (e.g., an empty page scan operation) as part of the PRDH operations. Then, at operation 502, the empty page scan component 200 obtains read trim values (e.g., signal distribution thresholds) and sets read trim offsets based on previously stored and accessed configuration information. The empty page scan component 200, at operation 503, selects empty (previously erased) blocks and/or partially empty blocks and, at operation 504, issues page read requests to WLs of the selected blocks or partially empty blocks. For example, the WLs can include a randomly selected WL from a list of WLs known to have defects or to be susceptible to stress (e.g. read stress) and/or one or more WLs adjacent to a last programmed WL (the WL to which data was last stored). In some cases, the read requests are only sent and read from WLs that have been previously tested and experimentally determined to have erasure reliability values that are below a threshold.

At operation 505, the empty page scan component 200 counts the number of 1's that result from reading the WLs of the selected blocks and/or pages to generate an error count value. The empty page scan component 200, at operation 506, determines whether the error count value transgresses a threshold by comparing the quantity of 1's that are counted or computed to a criterion or threshold. In response to determining that the error count value transgresses the threshold (e.g., the quantity of 1's is greater than the threshold value), the empty page scan component 200, at operation 511, marks the selected block or portions of the block for re-erasure or causes the selected block or portions of the block to be erased again by performing refresh operations. In response to determining that the error count value fails to transgress the threshold (e.g., the quantity of 1's is less than the threshold value), the empty page scan component 200, at operation 507, determines that the NDEP scan operation was successful and that the selected block or portions of the block are still empty and ready to be programmed.

In view of the disclosure above, various examples are set forth below. It should be noted that one or more features of an example, taken in isolation or combination, should be considered within the disclosure of this application.

Example 1: A system comprising: a memory sub-system comprising a set of memory components and a processing device, operatively coupled to the set of memory components and configured to perform empty page scan operations comprising: detecting a condition for performing read disturb handling operations for a portion of the set of memory components; determining that the portion of the set of memory components corresponds to an open block; and, in response to determining that the portion of the set of memory components corresponds to the open block, performing empty page scan operations relative to a last programmed word line (WL) of the open block.

Example 2. The system of Example 1, the operations comprising: determining that the last programmed WL corresponds to a boundary WL; and in response to determining that the last programmed WL corresponds to the boundary WL, selecting a target WL that is adjacent to the last programmed WL.

Example 3. The system of Example 2, the operations comprising: accessing a next WL that follows the last programmed WL as the target WL.

Example 4. The system of Example 3, wherein the target WL is associated with a plurality of subblocks, the operations comprising: selecting a random subblock from the plurality of subblocks; and, performing the empty page scan operations on the random subblock.

Example 5. The system of Example 4, the operations comprising: obtaining a list of mandatory WLs; selecting an additional random subblock from an additional plurality of subblocks associated with an individual WL of the list of mandatory WLs; and performing the empty page scan operations on the additional random subblock.

Example 6. The system of any one of Examples 1-5, wherein the memory sub-system comprises a three-dimensional (3D) NAND storage device.

Example 7. The system of any one of Examples 1-6, wherein the empty page scan operations comprise one or more NAND detect empty page (NDEP) scan operations.

Example 8. The system of Example 7, wherein a first of the NDEP scan operations is associated with selecting a random WL from a list of random empty mandatory WLs, and wherein a second of the NDEP scan operations is associated with selection of a WL adjacent to a boundary WL for performing the NDEP scan operations.

Example 9. The system of any one of Examples 1-8, the operations comprising: receiving a request to read a page from the open block; and determining that the page in the open block corresponds to an empty page, wherein the empty page scan operations are performed in response to determining that the page in the open block corresponds to the empty page.

Example 10. The system of Example 9, the operations comprising: refreshing the page in response to determining that the page fails the empty page scan operations.

Example 11. The system of any one of Examples 1-10, wherein detecting the condition comprises determining that a number of read operations performed on the portion of the set of memory components transgresses a read threshold count value.

Example 12. The system of Example 11, wherein the read threshold count value is associated with each memory component in the set of memory components.

Example 13. The system of Example 12, wherein the read threshold count value is adjusted based on a program erase count value of each memory component in the set of memory components, the read disturb handling operations comprise probabilistic read disturb handling operations for checking whether programmed pages in blocks are below a threshold limit.

Example 14. The system of any one of Examples 1-13, the operations comprising: in response to detecting the condition, determining that a page being read corresponds to a programmed page; and selecting a set of WLs for checking a read bit error rate associated with the page.

Methods and computer-readable storage medium with instructions for performing any one of the above Examples.

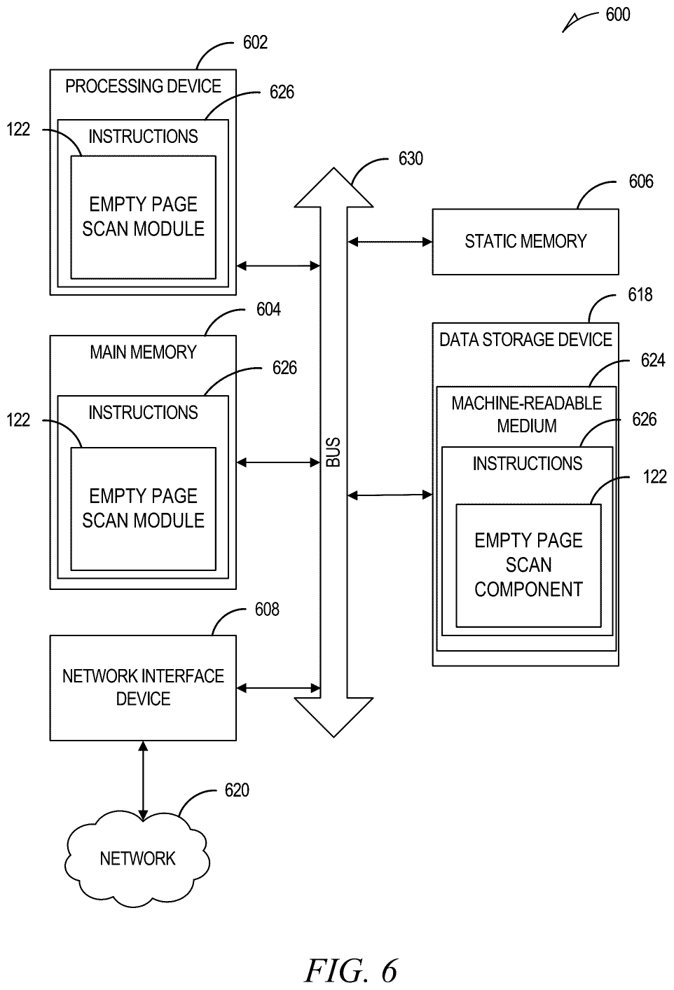

FIG. 6 illustrates an example machine in the form of a computer system 600 within which a set of instructions can be executed for causing the machine to perform any one or more of the methodologies discussed herein. In some examples, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the empty page scan component 122 of FIG. 1). In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory [ROM], flash memory, dynamic random access memory [DRAM] such as synchronous DRAM [SDRAM] or Rambus DRAM [RDRAM], etc.), a static memory 606 (e.g., flash memory, static random access memory] SRAM], etc.), and a data storage system 618, which communicate with each other via a bus 630.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an application specific integrated circuit (ASIC), a field programmable gate array (FPGA), a digital signal processor (DSP), a network processor, or the like. The processing device 602 is configured to execute instructions 626 for performing the operations and steps discussed herein. The computer system 600 can further include a network interface device 608 to communicate over a network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one example, the instructions 626 include instructions to implement functionality corresponding to firmware slot manager (e.g., the empty page scan component 122 of FIG. 1). While the machine-readable storage medium 624 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; read-only memories (ROM s); random access memories (RAMs); erasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine-readable (e.g., computer-readable) storage medium such as a read-only memory (ROM), random access memory (RAM), magnetic disk storage media, optical storage media, flash memory components, and so forth.

In the foregoing specification, examples of the disclosure have been described with reference to specific examples thereof. It will be evident that various modifications can be made thereto without departing from the examples of the disclosure as set forth in the following claims. The specification and drawings are, accordingly, to be regarded in an illustrative sense rather than a restrictive sense.

What is claimed is:

1. A system comprising:
a memory sub-system comprising a set of memory components;
a processing device, operatively coupled to the set of memory components and configured to perform empty page scan operations comprising:
detecting a condition for performing read disturb handling operations for a portion of the set of memory components;
determining that the portion of the set of memory components corresponds to an open block; and
in response to determining that the portion of the set of memory components corresponds to the open block, performing the empty page scan operations relative to a last programmed word line (WL) of the open block.

2. The system of claim 1, the operations comprising:
determining that the last programmed WL corresponds to a boundary WL; and
in response to determining that the last programmed WL corresponds to the boundary WL, selecting a target WL that is adjacent to the last programmed WL.

3. The system of claim 2, the operations comprising:
accessing a next WL that follows the last programmed WL as the target WL.

4. The system of claim 3, wherein the target WL is associated with a plurality of subblocks, the operations comprising:
selecting a random subblock from the plurality of subblocks; and
performing the empty page scan operations on the random subblock.

5. The system of claim 4, the operations comprising:
obtaining a list of mandatory WLs;
selecting an additional random subblock from an additional plurality of subblocks associated with an individual WL of the list of mandatory WLs; and
performing the empty page scan operations on the additional random subblock.

6. The system of claim 1, wherein the memory sub-system comprises a three-dimensional (3D) NAND storage device.

7. The system of claim 1, wherein the empty page scan operations comprise one or more NAND detect empty page (NDEP) scan operations.

8. The system of claim 7, wherein a first of the NDEP scan operations is associated with selecting a random WL from a list of random empty mandatory WLs, and wherein a second of the NDEP scan operations is associated with selection of a WL adjacent to a boundary WL for performing the NDEP scan operations.

9. The system of claim 1, the operations comprising:
receiving a request to read a page from the open block; and
determining that the page in the open block corresponds to an empty page, wherein the empty page scan operations are performed in response to determining that the page in the open block corresponds to the empty page.

10. The system of claim 9, the operations comprising:
refreshing the page in response to determining that the page fails the empty page scan operations.

11. The system of claim 1, wherein detecting the condition comprises determining that a number of read operations performed on the portion of the set of memory components transgresses a read threshold count value.

12. The system of claim 11, wherein the read threshold count value is associated with each memory component in the set of memory components.

13. The system of claim 12, wherein the read threshold count value is adjusted based on a program erase count value of each memory component in the set of memory components, the read disturb handling operations comprise probabilistic read disturb handling operations for checking whether programmed pages in blocks are below a threshold limit.

14. The system of claim 1, the operations comprising:
in response to detecting the condition, determining that a page being read corresponds to a programmed page; and
selecting a set of WLs for checking a read bit error rate associated with the page.

15. A method comprising:
detecting a condition for performing read disturb handling operations for a portion of a set of memory components;
determining that the portion of the set of memory components corresponds to an open block; and
in response to determining that the portion of the set of memory components corresponds to the open block, performing empty page scan operations relative to a last programmed word line (WL) of the open block.

16. The method of claim 15, comprising:
determining that the last programmed WL corresponds to a boundary WL; and
in response to determining that the last programmed WL corresponds to the boundary WL, selecting a target WL that is adjacent to the last programmed WL.

17. The method of claim 16, the operations comprising:
accessing a next WL that follows the last programmed WL as the target WL.

18. The method of claim 17, wherein the target WL is associated with a plurality of subblocks, comprising:
selecting a random subblock from the plurality of subblocks; and
performing the empty page scan operations on the random subblock.

19. The method of claim 18, comprising:
obtaining a list of mandatory WLs;
selecting an additional random subblock from an additional plurality of subblocks associated with an individual WL of the list of mandatory WLs; and
performing the empty page scan operations on the additional random subblock.

20. A non-transitory computer-readable storage medium comprising instructions that, when executed by a processing device, cause the processing device to perform operations comprising:
detecting a condition for performing read disturb handling operations for a portion of a set of memory components;
determining that the portion of the set of memory components corresponds to an open block; and
in response to determining that the portion of the set of memory components corresponds to the open block, performing empty page scan operations relative to a last programmed word line (WL) of the open block.
